(19) United States
(12) Patent Application Publication
(10) Pub. No.: US 2002/0094069 A1
(43) Pub. Date: Jul. 18, 2002

(54) Call-arrival signaling method

(76) Inventors: Aki Takahashi, Tokyo (JP); Toru Hasumi, Tokyo (JP)

Correspondence Address: LERNER, DAVID, LITTENBERG,, KRUMHOLZ & MENTLIK, 600 SOUTH AVENUE WEST, WESTFIELD, NJ, 07090, US

(21) Appl. No.: 10/035,655

(22) Filed: Nov. 1, 2001

(30) Foreign Application Priority Data
Nov. 1, 2000 (JP) 2000-335270
Oct. 19, 2001 (JP) 2001-321358

(51) Int. Cl. H04M 11/00

(52) U.S. Cl. 379/93.17

(57) ABSTRACT

A program execution device is connected with a predetermined communication terminal, and signals a call arrival when a call has arrived in the communication terminal during an execution of a program. With this arrangement, the program execution device securely informs the user about the call arrival in the communication terminal, even during the execution of the program. When necessary, the user can respond to the arrived call.

### CROSS-REFERENCE TO RELATED APPLICATIONS

The present application claims priority from Japanese Patent Application Nos. 2000-335270 filed on Nov. 1, 2000 and 2001-321358 filed on Oct. 19, 2001, the disclosures of which are hereby incorporated by reference herein.

### BACKGROUND OF THE INVENTION

The present invention relates to a call-arrival signaling method for informing a user about the arrival of a call at a predetermined communication terminal, a program execution device that can be connected to a communication terminal, a program execution system consisting of a program execution device and a communication terminal, a call-arrival signaling program for making a computer execute an operation of this system, and a recording medium recorded with the call-arrival signaling program.

In recent years, there has been a wide distribution of various kinds of entertainment apparatuses such as video game units. A large variety of game software exist for these video game units, and a user can enjoy a video game based on a choice of software. Among the video game units, there are those having a reproduction function like a DVD (digital versatile disk). According to this video game unit, on a television receiver, a user can enjoy watching a movie recorded on the DVD (hereinafter to be referred to as DVD appreciation).

Further, recently, there has also been a wide distribution of portable telephones, PHS (Personal Handyphone System: a brand name) terminals, and personal computers (including both desktop and portable types) provided with a communication function. By using these apparatuses, a user can easily communicate with other parties on telephone or by electronic mail. In particular, most portable telephones and PHS terminals (hereinafter, these will be collectively called portable telephones) have a data communication function including transmission/reception of electronic mail, in addition to a telephone function. These portable telephones are now essential for executing communications between users.

Playing a game and DVD appreciation using the above video game unit are excellent as entertainment. However, once a user has concentrated on playing a game or DVD appreciation, the user cannot easily shift his mind to others. Also, once a game or a movie has started, the user cannot easily make a pause on the game or the movie appreciation.

In the meantime, there are call arrivals (including both a telephone call arrival and an electronic mail reception) in the portable telephone regardless of the convenience of a user at a receiving side. In other words, a call arrival in the portable telephone can happen while a user of the portable telephone is in a game play or a DVD appreciation using the video machine. This might become interference to the user playing the game or in the DVD appreciation. In this case, the user can concentrate on the game or the DVD appreciation, when the portable telephone has been set not to generate an incoming-call tone (that is, when the silent setting is ON) or when the portable telephone has been set to vibrate by itself, upon arrival of a call (that is, when the vibrator setting is ON).

However, when the silent setting or the vibrator setting is ON, in many cases, a user concentrating on the game or the DVD appreciation is not aware of a call arrival in the portable telephone. If this call carries an urgent message, the user cannot respond to this. Even when the setting of an incoming-call tone of the portable telephone is ON, a user fully involved in the game or the DVD appreciation could miss the arrival of a call in the portable telephone. The above may similarly apply to a case when an electronic mail has arrived in a personal computer, for example.

### SUMMARY OF THE INVENTION

The present invention has been achieved with a view of the above problems. It is, therefore, an object of the invention to provide a call-arrival signaling method, a program execution device, a program execution system, and a recording medium recorded with a call-arrival signaling program, all capable of securely informing a user about a call arrival (an arrival of a telephone call, or a reception of an electronic mail) even when the user is concentrating on a video game or a DVD appreciation, and capable of enabling the user to respond to the call arrival (a response to the telephone call arrival, or a confirmation of the contents of the electronic mail) when necessary.

According to the present invention, it is possible to detect a connection with a predetermined communication terminal, to detect the presence or absence of a call arrival in the communication terminal during the execution of a program, and to signal the call arrival in a recognizable state when the presence of the call has been detected.

In other words, according to the present invention, it is possible to make a user recognize securely a call arrival in a communication terminal, even when the user is in the middle of executing a program. Further, it is possible to make the user recognize the contents of the arrived call when necessary. Therefore, according to the present invention, it is possible to securely inform a user about a call arrival (an arrival of a telephone call, or a reception of an electronic mail) in a portable telephone or the like, even when the user is concentrating on a video game. Further, it is possible to enable the user to respond to the call arrival (a response to the telephone call arrival, or a confirmation of the contents of the electronic mail) when necessary.

Other and further objects and features of the present invention will become obvious upon understanding of the illustrative embodiments about to be described in connection with the accompanying drawings or will be indicated in the appended claims, and various advantages not referred to herein will occur to one skilled in the art upon employing the invention in practice.

### BRIEF DESCRIPTION OF DRAWINGS

FIG. 1 is a diagram showing a total structure of an entertainment system according to an embodiment of the present invention.

FIG. 2 is a flowchart showing the flow of a decision processing of an automatic display and a manual display of a dialog, and a telephone call arrival and an electronic mail reception, in a call-arrival signaling application program according to the embodiment.

FIG. 3 is a flowchart showing a detail of a dialog automatic display processing routine at the time of a telephone call arrival, in the call-arrival signaling application program according to the embodiment.

FIG. 4 is a diagram used for explaining a display example of a television monitor screen and a call arrival dialog.

FIG. 5 is a diagram showing one example of a telephone call arrival dialog.

FIG. 6 is a flowchart showing a detail of a dialog automatic display processing routine at the time of an electronic mail reception, in the call-arrival signaling application program according to the embodiment.

FIG. 7 is a diagram showing one example of an electronic mail reception dialog.

FIG. 8 is a diagram showing one example of an electronic mail confirmation dialog.

FIG. 9 is a diagram showing one example of an electronic mail display dialog.

FIG. 10 is a diagram showing one example of an instruction wait display dialog.

FIG. 11 is a diagram showing one example of a pause-possible setting screen.

FIG. 12 is a flowchart showing a detail of a dialog manual display processing routine at the time of a telephone call arrival, in the call-arrival signaling application program according to the embodiment.

FIG. 13 is a flowchart showing a detail of a dialog manual display processing routine at the time of an electronic mail reception, in the call-arrival signaling application program according to the embodiment.

FIG. 14 is a block diagram showing an outline structure of an internal circuit of a video game unit according to the present embodiment.

### DETAILED DESCRIPTION

Various embodiments of the present invention will be described with reference to the accompanying drawings. It is to be noted that the same or similar reference numerals are applied to the same or similar parts and elements throughout the drawings, and the description of the same or similar parts and elements will be omitted or simplified.

A Total Structure of an Entertainment System of the Present Invention

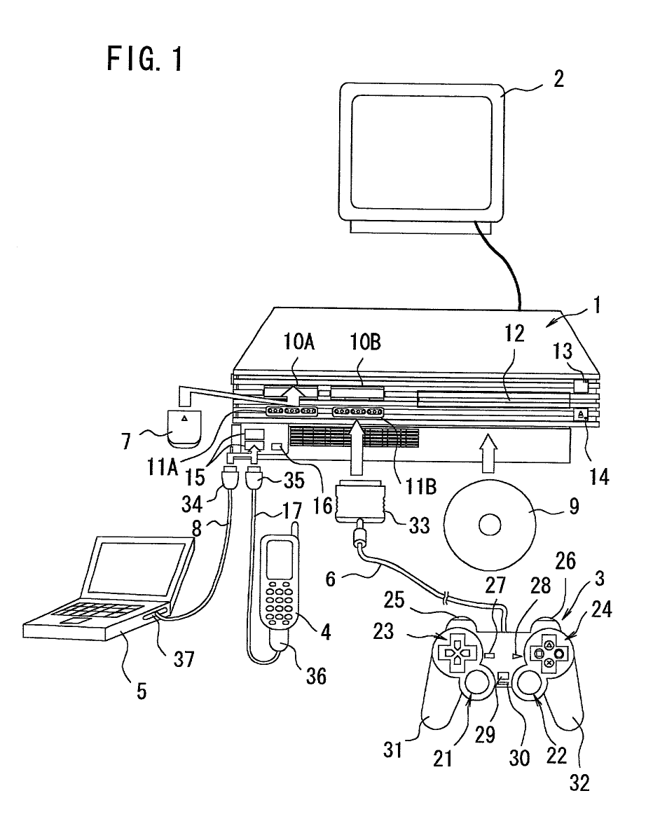

FIG. 1 shows a schematic structure of an entertainment system (for example, a video game system) according to an embodiment of the present invention.

The entertainment system shown in FIG. 1 is a video game system consisting of an entertainment apparatus (a video game unit 1, for example, in the present embodiment), a controller 3 as an operation terminal operated by a user (a game player), and a television monitor 2 for displaying the contents of a game and outputting sound during play of the game.

An Outline of the Video Game Unit

The video game unit 1 is provided with memory card slots 10A and 10B into which a memory card 7 may be detachably inserted; controller ports 11A and 11B to which a connector 33 of a cable 6 of the controller 3 may be detachably connected; a disk tray 12 to which an optical disk 9 like a DVD-ROM or a CD-ROM may be mounted; an open button 14 for opening the disk tray 12; an ON/standby/reset button 13 for turning on, standing by, and resetting the power source; an IEEE (Institute of Electrical and Electronics Engineers) 1394 connection terminal 16; USB (Universal Serial Bus) connection terminals 15; and other parts not shown, like a power switch, a sound/video output terminal (an AV multi-output terminal), a PC card slot, an optical digital output terminal, and an AC power source input terminal.

The USB connection terminals 15 can be connected with a portable telephone (including a PHS) 4 and a desktop or portable personal computer 5, via exclusive cables 17 and 8, respectively. The exclusive cable 17 has a USB connector 35 at one end, and has a portable telephone connector 36 at the other end. The exclusive cable 17 further has a built-in signal transformation circuit between the portable telephone 4 and the video game unit 1. The exclusive cable 8 has a USB connector 34 at one end, and has a PC card 37 at the other end. In the above video game unit 1, the terminals to which the portable telephone 4 and the personal computer 5 are connected are not limited to the USB connection terminals 15. The portable telephone 4 and the personal computer 5 may be connected to the IEEE 1394 connection terminal 16 or the controller ports 11A and 11B that are provided in the video game unit 1, or the PC card slot not shown.

The video game unit 1 can execute a video game based on a video game application program, and can reproduce (decode) audio data recorded on a CD or video data and audio data recorded on a DVD. At the same time, the video game unit 1 can operate based on other various kinds of application programs. For example, it is possible to inform a user about a telephone call arrival and an electronic mail reception based on a call-arrival signaling application program according the embodiment to be described later.

The game application program and the call-arrival signaling application program relating to the present embodiment are loaded after being read from the optical disk 9 like a DVD-ROM or a CD-ROM or from a semiconductor memory like the memory card 7. Also, the game application program and the call-arrival signaling application program may be downloaded from the outside via the USB connection terminal 15, the IEEE 1394 connection terminal 16, or the PC card slot.

The signaling of a telephone call arrival and the signaling of an electronic mail arrival relating to the present embodiment will be explained later in detail.

An Outline of the Controller

The controller 3 is provided with a right holder 32 held in the palm of the right hand and a left holder 31 held in the palm of the left hand of an operator (player) of the controller 3, respectively, so that these holders are grasped within the palms; a left console 23 and a right console 24 to be operated with the thumbs of the left and right hands, respectively, when the player holds the holders 31 and 32 with the left and right hands, respectively; a left analog console 21 and a right analog console 22 capable of carrying out analog operations (joystick operations) with the thumbs of the left and right hands, respectively; a left first press button 25 and a right first press button 26 to be pressed with the left and right forefingers, respectively; and a left second press button (not shown) and a right second press button (not shown) to be pressed with the left and right middle fingers, respectively. The left console 23 is provided with “up”, “down”, “left”, and “right” buttons for the player to operate for moving a game character, for example, in up, down, left, and right directions, respectively, on the screen. In the meantime, the right console is provided with four instruction buttons (“δ”, “□”, “×”, and “∘” buttons) that are allocated with mutually different functions based on a game application, such as, for example, the setting and execution of a function of a game character. Particularly, in the present embodiment, the “Δ” button has been allocated with the function of a menu select button, the “□” button has been allocated with the function of a title display button, the “×” button has been allocated with the function of a cancellation or pause button, and the “∘” button has been allocated with the function of a determination button, for example.

The controller 3 is further provided with a mode selection switch 29 for selecting a mode of operation or pause of the functions of the left and right consoles 23 and 24 and the left and right analog consoles 21 and 22, respectively; a light display section 30 for making the player recognize a selected operation mode based on a light display of an LED light-emitting diode or the like; a start button 28 for instructing a reproduction or suspension; and a select button 27 for instructing a menu display or a console panel display on the monitor screen.

When these buttons and consoles have been operated, the controller 3 generates an operation signal corresponding to each of these operations, and transmits the signal to the video game unit 1 via the cable 6.

Within each of the left and right holders 31 and 32 of the controller 3, there is provided a vibration generating mechanism that generates vibrations by rotating a weight mounted eccentrically with respect to the rotary axis of a motor. The vibration generating mechanism can operate according to an instruction from the video game unit 1. In other words, the controller 3 also has a function for transmitting the vibration to the hands of the player by operating the vibration generating mechanism.

Operation of the Call-Arrival Signaling Application Program: Outline of the Operation

Next, the telephone-call arrival signaling operation and the electronic mail reception signaling operation that the video game unit 1 of the present embodiment carries out based on the call-arrival signaling application program will be explained in detail. The telephone-call arrival signaling operation and the electronic mail reception signaling operation explained below are exemplary only, and the present invention is not limited to these examples.

The call-arrival signaling application program relating to the present embodiment is an application program for signaling a call arrival to a user by displaying on the television monitor 2, generating a voice, or generating a vibration with the vibration generating mechanism of the controller 3, and for enabling the user to confirm the contents of the arrived call when necessary. The call-arrival signaling application program performs the above when the call has arrived (a telephone call arrival or an electronic mail reception) in the portable telephone 4 or the personal computer 5 connected via the exclusive cable 17 or 8, during an execution of a video game or a DVD reproduction in the video game unit 1.

The call-arrival signaling application program according to the present embodiment has a dialog automatic display function for automatically displaying a call arrival dialog for signaling the arrival of a call to a user on the television monitor screen when the call has arrived during a game play or a DVD reproduction. The call-arrival signaling application program further has a dialog manual display function for signaling a call arrival to the user when the call has arrived during a game play or a DVD reproduction and for displaying the call arrival dialog only when the user has clearly instructed the display. The call-arrival signaling application program can select either the dialog automatic display function or the dialog manual display function. When the dialog automatic display function is set to ON, the user can securely know a call arrival. Further, the user does not need to operate to confirm a call arrival when the call has arrived during a game or a DVD appreciation. On the other hand, when the dialog manual display function is set to ON (or when the dialog automatic display function is set to OFF), a game or a DVD appreciation is not interrupted due to a sudden display of a call arrival dialog. Further, the user can confirm the call arrival when necessary.

Further, the call-arrival signaling application program according to the present embodiment has a pause-possible setting function for automatically pausing (suspending) the progress of a game or a DVD appreciation when a call arrives during the game or the DVD appreciation, and a pause-impossible setting function for not pausing the progress of a game or a DVD appreciation even when a call arrives during the game or the DVD appreciation. The call-arrival signaling application program can select either the pause-possible setting function or the pause-impossible setting function. When the pause-possible function has been set to ON, the user does not need to pause during a game or a DVD appreciation when a call arrives during the game or the DVD appreciation. On the other hand, when the pause-impossible function has been set to ON (or when the pause-possible function has been set to OFF), it is possible to prevent the user from intentionally making time to prepare a game strategy by interrupting the game based on an intentional arrival of a call during the game that should not be permitted in principle.

In the call-arrival signaling application program according to the present embodiment, it is possible to selectively combine the dialog automatic display function or the dialog manual display function, and the pause-possible setting function or the pause-impossible setting function. For example, when the dialog automatic display function is set to ON, it is possible to set either the pause-possible function to ON or the pause-impossible function to ON (or the pause-possible function to OFF). Further, in the call-arrival signaling application program according to the present embodiment, when the dialog manual display function is set to ON (or when the dialog automatic display function is set to OFF), it is possible to set either the pause-possible function to ON or the pause-impossible function to ON.

Further, the call-arrival signaling application program according to the present embodiment has a function for deciding whether a game application program or a DVD reproduction program under execution corresponds to the pause function, deciding whether it is impossible to pause at present although the program corresponds to the pause function, and carrying out optimum processing corresponding to the pause function or state. One possible arrangement is that the dialog display and pause functions are deactivated for the case which prefers continuation, such as displaying the moving image (movie) of a DVD, for example, and that the pause function is activated even when the game is proceeding if the game has little movement, such as puzzle games.

Further, the call-arrival signaling application program according to the present embodiment has a function for dividing processing between the case where the call arrival is a telephone call arrival and the call receiver cannot be on the phone unless the call arrival is continuous, and the case where the call arrival is an electronic mail reception and the call receiver can confirm the contents even after finishing the call arrival, and for carrying out optimum processing corresponding to the type of call arrival, namely, the telephone call arrival or the electronic mail reception.

Further, the call-arrival signaling application program according to the present embodiment can also have a function for combining a setting of a type of call arrival and a pause-possible/pause-impossible function. The call-arrival signaling application program according to the present embodiment can automatically select a setting of the type of call arrival and the pause-possible/pause-impossible function. For example, it is possible to set the pause-impossible function in the case of a telephone call arrival, and the pause-possible function in the case of an electronic mail reception. With this arrangement, the call-arrival signaling application program according to the present embodiment can make a setting such that the play of a game or a DVD appreciation is not interrupted only in the case of a telephone call arrival.

A processing flow of the call-arrival signaling application program according to the present embodiment that realizes the above setting will be explained below with reference to each drawing. The call arrival processing flow explained below will be realized based on the call-arrival signaling application program according to the present embodiment being operated on a CPU (central processing unit) incorporated in the video game unit 1 shown in FIG. 1.

The decision of Dialog Automatic Display/Manual Display and Telephone Call Arrival/Electronic Mail Reception

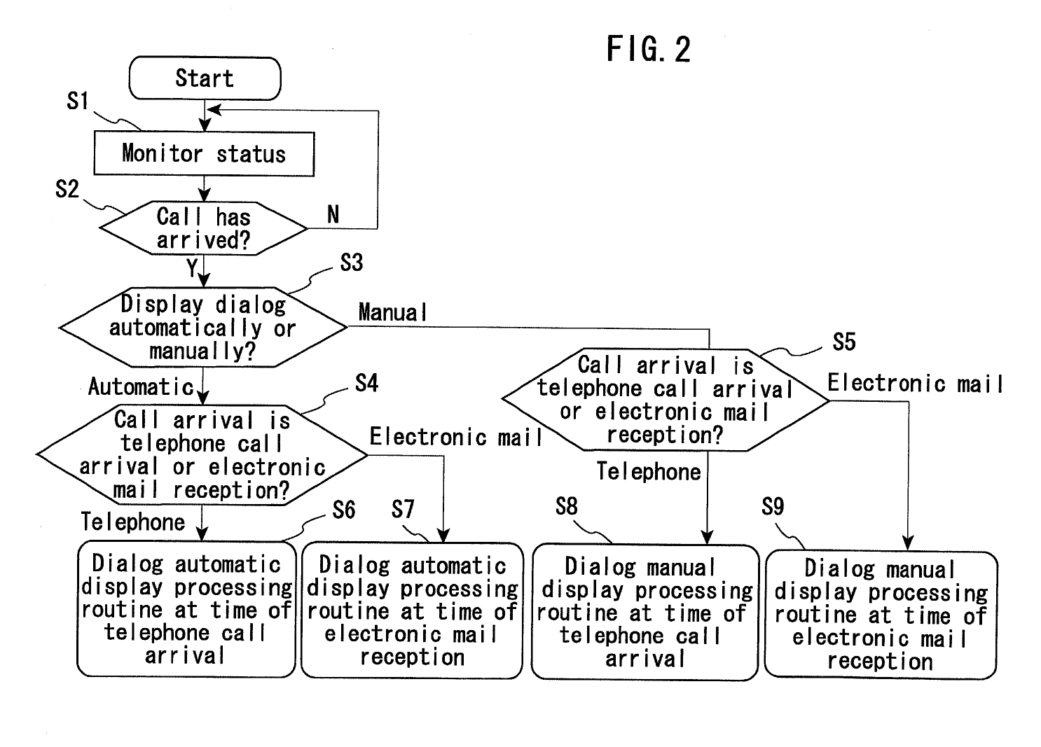

First, in FIG. 2, the call-arrival signaling application program according to the present embodiment is started when the portable telephone 4 or the personal computer 5 has been connected to the video game unit 1 via the exclusive cable 17 or 8, or when a user has clearly provided an instruction to start by using the controller 3, for example. To simplify the explanation, only a case where the portable telephone 4 has been connected to the video game unit 1 via the exclusive cable 17 will be explained below.

After starting, at step S1, the call-arrival signaling application program monitors the reception status of the portable telephone 4 based on communications with the CPU (not shown) within the portable telephone 4 connected via the exclusive cable 17, or communications with a signal processor within the portable telephone 4. Further, at step S2, the call-arrival signaling application program detects the presence or absence of the call arrival of a telephone call or electronic mail. When the call arrival of a telephone call has been detected at step S2, the call-arrival signaling application program proceeds to the next process at step S3.

At step S3, the call-arrival signaling application program determines whether the dialog automatic display function has been set to ON or the dialog manual display function has been set to ON (or the dialog automatic display function has been set to OFF). When the dialog automatic display function has been set to ON at step S3, the call-arrival signaling application program proceeds to a process at and after step S4, and when the dialog manual display function has been set to ON at step S3, the call-arrival signaling application program proceeds to a process at and after step S5.

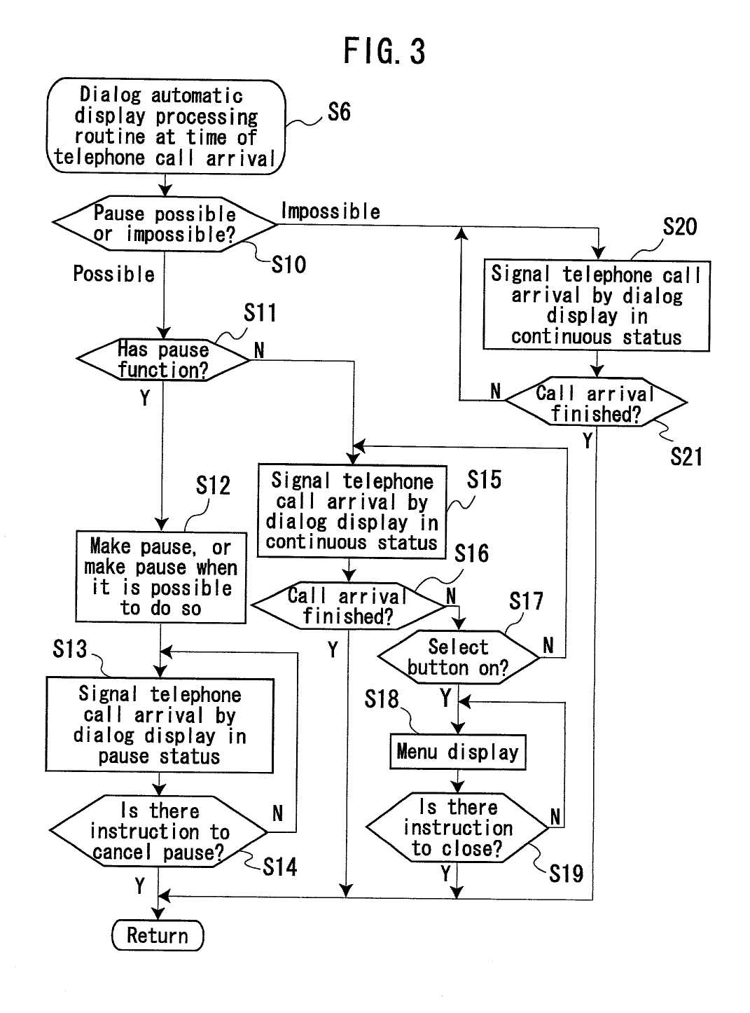

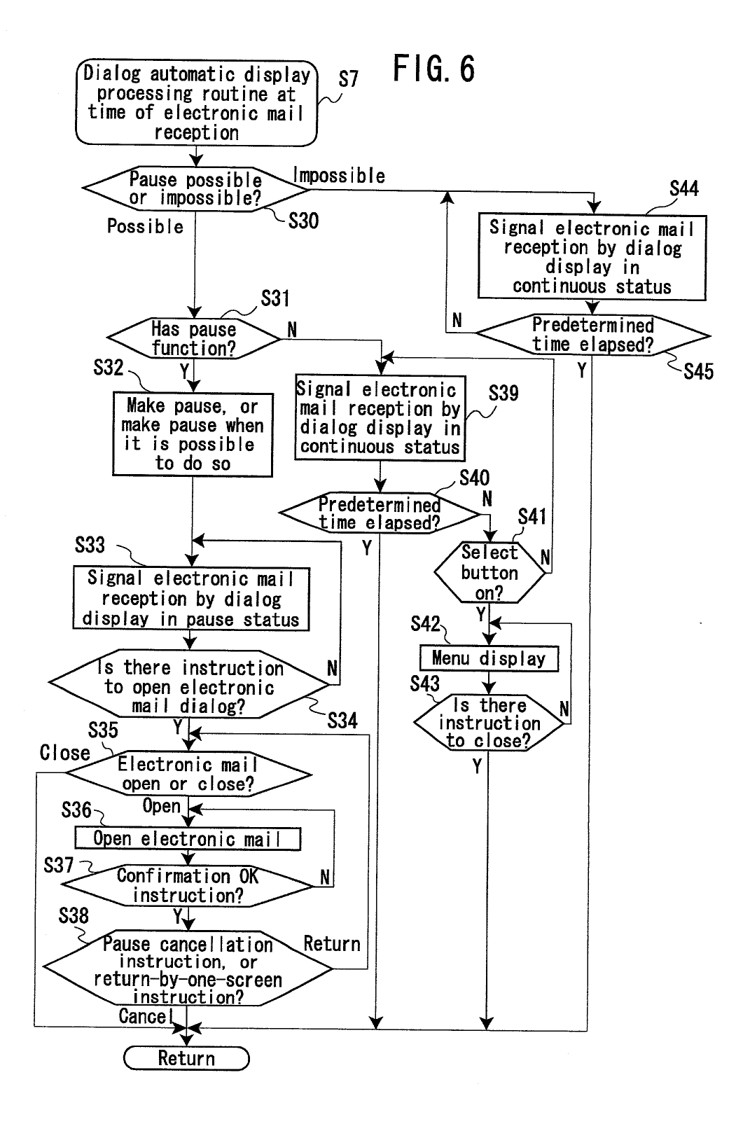

At step S4, the call-arrival signaling application program determines whether the call arrival is a telephone call arrival or an electronic mail reception. When the call-arrival signaling application program has determined at step S4 that the call arrival is a telephone call arrival, the call-arrival signaling application program proceeds to step S6 of a dialog automatic display processing routine at the time of a telephone call arrival, as shown in FIG. 3 to be described later. On the other hand, when the call-arrival signaling application program has determined at step S4 that the call arrival is an electronic mail reception, the call-arrival signaling application program proceeds to step S7 of a dialog automatic display processing routine at the time of an electronic mail reception, as shown in FIG. 6 to be described later.

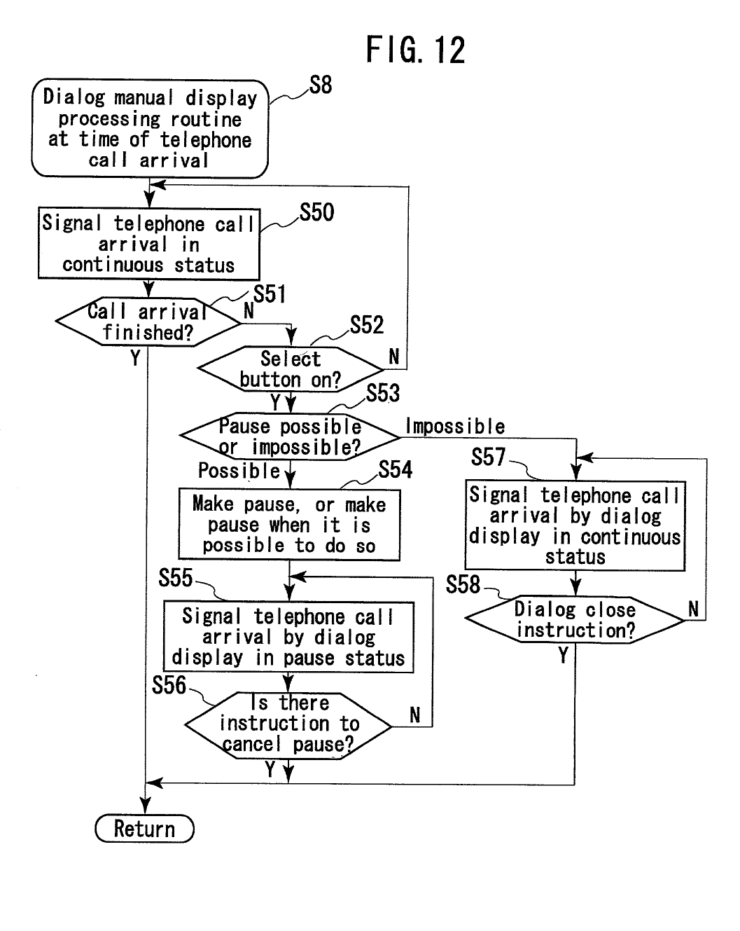

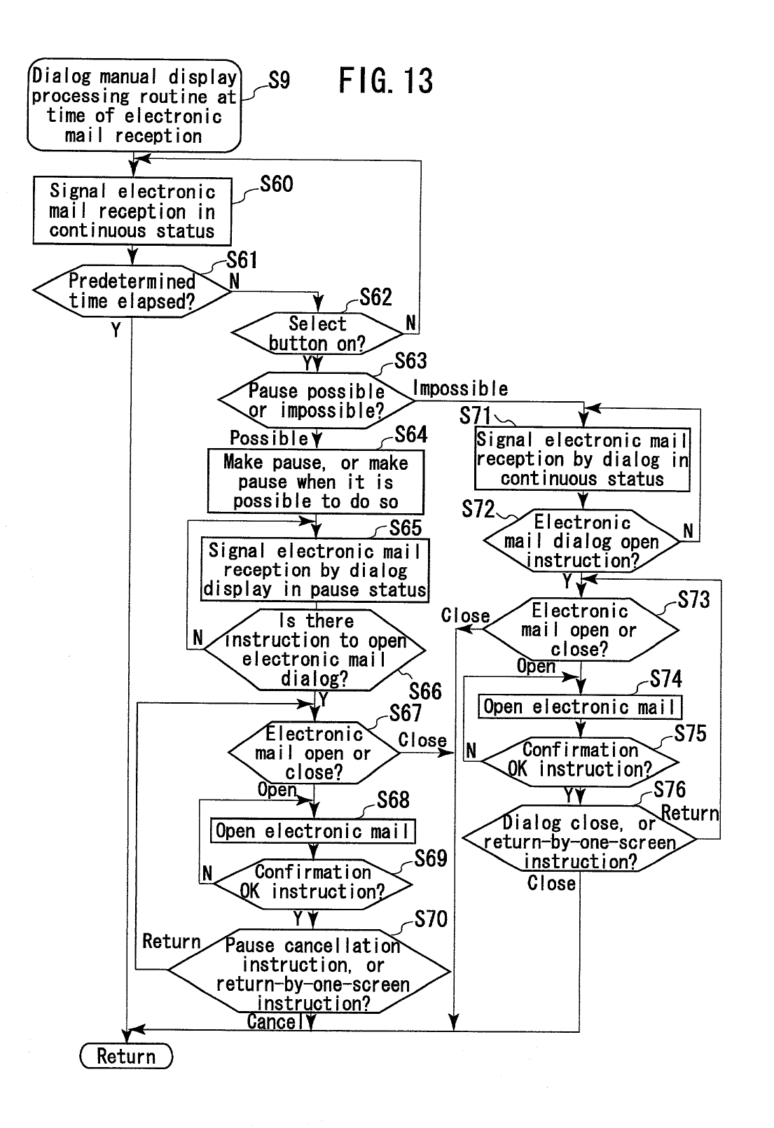

At step S5, the call-arrival signaling application program determines whether the call arrival is a telephone call arrival or an electronic mail reception. When the call-arrival signaling application program has determined at step S5 that the call arrival is a telephone call arrival, the call-arrival signaling application program proceeds to step S8 of a dialog manual display processing routine at the time of the telephone call arrival, as shown in FIG. 12 to be described later. On the other hand, when the call-arrival signaling application program has determined at step S5 that the call arrival is an electronic mail reception, the call-arrival signaling application program proceeds to step S9 of a dialog manual display processing routine at the time of the electronic mail reception, as shown in FIG. 13 to be described later.

A Dialog Automatic Display Processing Routine at the time of a Telephone Call Arrival

In the dialog automatic display processing routine at the time of a telephone call arrival shown in FIG. 3, the call-arrival signaling application program determines at step S10 whether the pause-possible function has been set to ON or the pause-impossible function has been set to ON (or the pause-possible function has been set to OFF). When the pause-possible function has been set to ON at step S10, the call-arrival signaling application program proceeds to a process at step 11, and when the pause-impossible function ha s been set to ON (or the pause-possible function has been set to OFF) at step S10, the call-arrival signaling application program proceeds to a process at step S20.

At step S11, the call-arrival signaling application program determines whether the game application program or the DVD reproduction program supports the pause function. In general, it is possible to pause during a DVD reproduction. Therefore, in the subsequent explanation, it will be assumed that the DVD reproduction program supports the pause function. When the call-arrival signaling application program has determined at step S11 that the pause function has been supported, the call-arrival signaling application program proceeds to a process at step S12. When the call-arrival signaling application program has determined at step S11 that the pause function has not been supported, the call-arrival signaling application program proceeds to a process at step S15.

At step S12, the call-arrival signaling application program pauses the game or the DVD appreciation (a suspension, in the case of the DVD, the same state as that when the “Δ” button of the controller 3 has been pressed). However, if it is not possible to pause at present because of the state of progress of the game, for example, the call-arrival signaling application program pauses when it becomes possible to pause after the pause-impossible state has been cancelled. The process of pausing when it has become possible to pause can be realized by continuously generating a pause instruction signal until it becomes possible to interrupt the game or the DVD appreciation. After the processing at step S12, the call-arrival signaling application program proceeds to a process at step S13.

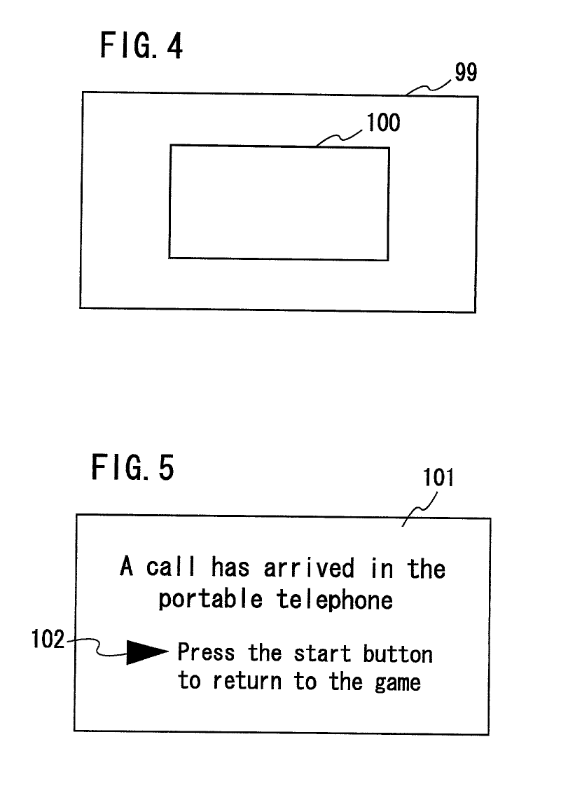

At step S13, the call-arrival signaling application program signals a telephone call arrival by displaying a call arrival dialog in a pause state of the game or the DVD appreciation. In other words, the call-arrival signaling application program makes a telephone call arrival dialog 101 shown in FIG. 5, displayed as a call arrival dialog 100 at a predetermined position on a television monitor screen 99 as shown in FIG. 4, for example. For example, when a call has arrived in a portable telephone during the play of a game, the call-arrival signaling application program displays the message “A call has arrived in the portable telephone”, the message “Press the start button to return to the game”, and a predetermined mark 102 showing the shape of the start button 28 on the controller 3, all within the telephone call arrival dialog 101 in the example shown in FIG. 5. With this arrangement, a user can know that the call has arrived in the portable telephone even if the user has been concentrating on playing the game. The user can also recognize that it is possible to return to the game when the start button 28 of the controller 3 is pressed.

Reference is again made to the flowchart shown in FIG. 3. After carrying out the signaling of the telephone call arrival in the telephone call arrival dialog 101 at step S13, the call-arrival signaling application program determines at step S14 whether the user has instructed that the pause state be cancelled, that is, whether the start button 28 of the controller 3 has been pressed. When the user has not pressed the start button 28 and has not instructed that the pause state be cancelled, the call-arrival signaling application program repeats the process at step S13 and step S14. When the call-arrival signaling application program determines that the user has pressed the start button 28 to instruct that the pause state be cancelled, the call-arrival signaling application program closes the display of the telephone call arrival dialog 101. Thereafter, the call-arrival signaling application program cancels the pause state, and returns to step S1 shown in FIG. 2, thereby to return to the game playing state or the DVD reproduction state.

When the call-arrival signaling application program has determined at step Sll that there is no pause function, the call-arrival signaling application program proceeds to a process at step S15. The call-arrival signaling application program signals the telephone call arrival by displaying the telephone call arrival dialog 101 and the game playing state or the DVD reproduction state is continued.

Thereafter, the call-arrival signaling application program proceeds to a process at step S16, and determines whether the telephone call arrival has finished. When the call-arrival signaling application program determines that the call arrival has finished, the call-arrival signaling application program closes the display of the telephone call arrival dialog 101, returns to step S1 shown in FIG. 2, and returns the state to the game playing state.

On the other hand, when the telephone call arrival has not finished at step S16, the call-arrival signaling application program determines at step S17 whether the select button 27 on the controller 3 has been pressed. When the call-arrival signaling application program has determined at step S17 that the select button 27 has not been pressed, the call-arrival signaling application program returns to the process at step S15. When a determination has been made that the select button 27 has been pressed, the call-arrival signaling application program proceeds to a process at step S18.

At step S18, the call-arrival signaling application program searches for a function capable of pausing the game application program other than the pause function. The call-arrival signaling application program stops the game by using the stop function obtained as a result of this searching. When there is a menu display function of a game application program as the stop function, for example, the call-arrival signaling application program stops the game play by using this menu display function, and displays this menu screen. In other words, even if the game application program does not support the pause function, the call-arrival signaling application program according to the present embodiment can pause the game by using the menu display function of the game application program. The use of the menu display function is one example. It is, of course, possible for the call-arrival signaling application program to use a function other than the pause function that can stop the game when such a function is available.

After the menu display at step S18, the call-arrival signaling application program determines at step S19 whether the user has selected an item for closing the menu display from among the menu items displayed. The call-arrival signaling application program repeats the processing at step S18 and step S19 until a close instruction has been made. When a close instruction has been made, the call-arrival signaling application program closes the telephone call arrival dialog 101 and the menu display, cancels the stop state, and returns to the processing at step S1 shown in FIG. 2, thereby to return to the game playing state.

When the call-arrival signaling application program has determined at step S10 that the pause-impossible function has been set to ON (or when the pause-possible function has been set to OFF), the call-arrival signaling application program proceeds to a process at step S20. The call-arrival signaling application program signals the telephone call arrival by displaying the telephone call arrival dialog 101 in the state that play of the game is continued.

Thereafter, the call-arrival signaling application program proceeds to processing at step S21, and determines whether the telephone call arrival has finished. The call-arrival signaling application program repeats the processing at step S20 and step S21 when the call arrival has not finished. When a decision has been made that the call arrival has finished, the call-arrival signaling application program closes the display of the telephone call arrival dialog 101, returns to step S1 shown in FIG. 2, and returns to the game playing state or the DVD reproduction state.

When a call has arrived in the portable telephone 4, the user extracts the USB connector 35 from the USB connection terminal 15, or extracts the portable telephone connector 36 from the portable telephone 4, in order to take the call on the phone. In this case, in the call-arrival signaling application program according to the present embodiment, it is possible to operate the call arrival dialog thereafter.

As explained above, according to the algorithm of the flowchart shown in FIG. 3, when the pause-possible function has been set to ON and also when the pause function has been supported, the play of a game or a DVD appreciation is set to the pause state and the telephone call arrival dialog is displayed upon arrival of a telephone call. Further, when the pause function has not been supported, the call arrival dialog is displayed while continuing the play of the game, or the call arrival dialog is displayed in a state that the play of the game is paused based on the menu display function. In this way, it is possible to securely inform the user about the telephone call arrival.

Further, according to the algorithm of the flowchart shown in FIG. 3, when the pause-possible function has been set to OFF, the call arrival dialog is displayed while continuing the play of a game or a DVD appreciation, thereby making it possible to inform the user about the arrival of the telephone call. At the same time, it is possible to prevent the user from intentionally making time to prepare a game strategy by interrupting the game based on the intentional arrival of a call during the game that should not be permitted in principle.

A dialog Automatic Display Processing Routine at the Time of an Electronic Mail Reception

Next, the dialog automatic display processing routine (step S7) at the time of an electronic mail reception will be explained with reference to FIG. 6.

In the dialog automatic display processing routine at the time of an electronic mail reception shown in FIG. 6, the call-arrival signaling application program determines at step S30 whether the pause-possible function has been set to ON or the pause-impossible function has been set to ON (or the pause-possible function has been set to OFF). When the pause-possible function has been set to ON at step S30, the call-arrival signaling application program proceeds to a process at step S31, and when the pause-impossible function has been set to ON (or the pause-possible function has been set to OFF) at step S30, the call-arrival signaling application program proceeds to a process at step S44.

At step S31, the call-arrival signaling application program determines whether the game application program or the DVD reproduction program supports the pause function. Like in the example shown in FIG. 3, it will also be assumed that the DVD reproduction program supports the pause function. When the call-arrival signaling application program has determined at step S31 that the pause function has been supported, the call-arrival signaling application program proceeds to a process at step S32. When the call-arrival signaling application program has determined at step S31 that the pause function has not been supported, the call-arrival signaling application program proceeds to a process at step S39.

At step S32, the call-arrival signaling application program pauses the game or the DVD appreciation. If it is not possible to pause at present like in the example shown in FIG. 3, the call-arrival signaling application program pauses when it becomes possible to pause after the pause-impossible state has been cancelled. After the processing at step S32, the call-arrival signaling application program proceeds to a process at step S33.

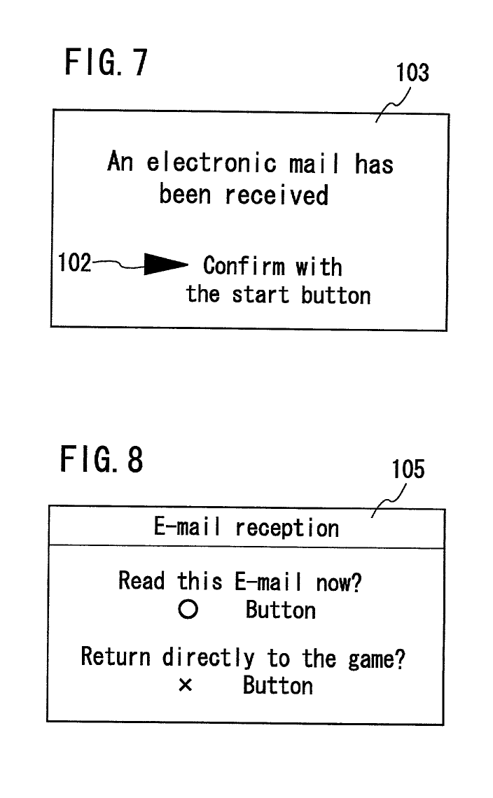

At step S33, the call-arrival signaling application program signals an electronic mail reception by displaying a call arrival dialog (an electronic mail reception dialog) in a pause state of the game or the DVD reproduction. In other words, the call-arrival signaling application program makes an electronic mail reception dialog 103 shown in FIG. 7, displayed as the call arrival dialog 100 on the television monitor screen 99 as shown in FIG. 4, for example. The electronic mail reception dialog 103 displays the message “An electronic mail has been received”, the message “Confirm with the start button”, and a mark 102 showing the shape of the start button 28, as shown in FIG. 7, for example. With this arrangement, a user can know that the electronic mail has been received even if the user has been concentrating on playing the game. The user can also confirm the contents of the received electronic mail when the start button 28 of the controller 3 is pressed.

Reference is again made to the flowchart shown in FIG. 6. After carrying out the signaling of the electronic mail reception in the electronic mail reception dialog at step S33, the call-arrival signaling application program determines at step S34 whether the user has pressed the start button 28 of the controller 3 to indicate the confirmation of the contents of the electronic mail. When the call-arrival signaling application program has determined at step S34 that the user has not indicated the confirmation of the contents of the electronic mail, the call-arrival signaling application program repeats the process at step S33 and step S34. When the call-arrival signaling application program has determined that the user has pressed the start button 28 to indicate the confirmation of the contents of the electronic mail, the call-arrival signaling application program proceeds to a process at step S35.

At step S35, the call-arrival signaling application program changes the electronic mail reception dialog 103 shown in FIG. 7 to a mail confirmation dialog 105 shown in FIG. 8. The electronic mail confirmation dialog 105 displays the message “Read this e-mail now?”, the characters “∘ button” for expressing that the button for instructing that the received mail be read is the “∘” button on the controller 3, the message “Return directly to the game?”, and the characters “× button” for expressing that the button for instructing that the game be returned to is the “×” button on the controller 3, for example. After displaying the electronic mail confirmation dialog 105 shown in FIG. 8, the call-arrival signaling application program determines whether the user has instructed that the electronic mail be read (whether the user has pressed the “∘” button) or whether the user has instructed that the game be returned to (whether the user has pressed the “×” button). When the call-arrival signaling application program determines that the user has pressed the “×” button, the call-arrival signaling application program closes the electronic mail confirmation dialog 105, cancels the pause state, and returns to step SI shown in FIG. 2, thereby to return to the game playing state or the DVD reproduction state. On the other hand, when the call-arrival signaling application program has determined at step S35 that the user has pressed the “∘” button to instruct that the electronic mail be read, the call-arrival signaling application program proceeds to a process at step S36.

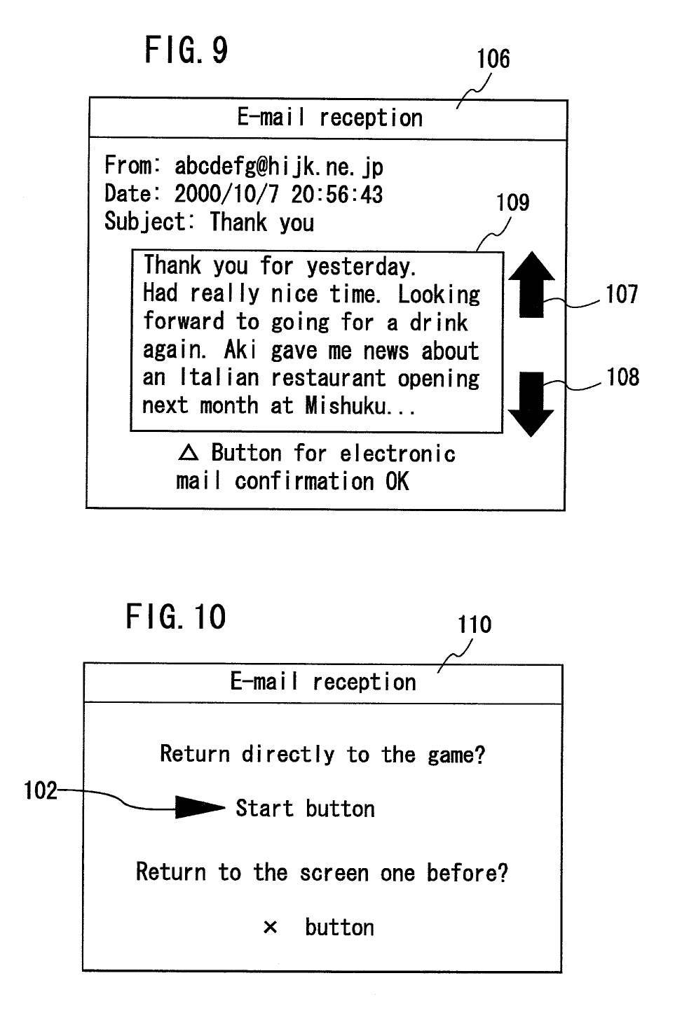

At step S36, the call-arrival signaling application program accesses the CPU of the portable telephone 4 shown in FIG. 1, and instructs the CPU to transfer the received electronic mail to the video game unit 1. Then, the call-arrival signaling application program changes the display of the electronic mail confirmation dialog 105 to the display of an electronic mail display dialog 106 for expressing the contents of the transferred electronic mail, as shown in FIG. 9. The electronic mail display dialog 106 shows characters for expressing a transmitter's address, characters for expressing a transmission date and time, characters for expressing a title, an electronic mail display section 109 having characters for expressing the contents of the actual electronic mail, an upward scroll key 107 for scrolling sentences of the electronic mail to the upward direction, a downward scroll key 108 for scrolling sentences to the downward direction, and the message “Δ button for electronic mail confirmation OK” for expressing that the button for the user to instruct that the user has confirmed the contents of the electronic mail is the “Δ” button on the controller 3, for example. In the example shown in FIG. 9, “From: abcdefg@hijk.ne.jp” is displayed as the characters for expressing the transmitter's address. “Date: 2000/10/7 20:56:43” is displayed as the characters for expressing the transmission date and time. “Thank you” is displayed as an example of the characters for expressing the title. In the example shown in FIG. 9, only the received electronic mail is displayed. However, it is also possible to display electronic mail received in the past or electronic mail transmitted in the past that is stored in the portable telephone 4.

Reference is again made to the flowchart shown in FIG. 6. Next, the call-arrival signaling application program determines at step S37 whether the user has indicated a confirmation of the electronic mail in the electronic mail display dialog 106. When the call-arrival signaling application program has determined at step S37 that the user has not yet pressed the “Δ” button on the controller 3 and has not confirmed the contents yet, the call-arrival signaling application program continues the process at step S36 and S37. When the call-arrival signaling application program has determined at step S37 that the user has pressed the “Δ” button on the controller 3 and has confirmed the contents, the call-arrival signaling application program proceeds to a process at step S38.

At step S38, the call-arrival signaling application program changes the display of the electronic mail display dialog 106 shown in FIG. 9 to the display of an instruction wait display dialog 110 shown in FIG. 10. The instruction wait display dialog 110 shows the message “Will you return to the game?”, the characters “start button” for expressing that the button to be pressed to instruct that the game be returned to is the start button 28 on the controller 3, a predetermined mark 102 for expressing the shape of the button, the message “Will you return to the screen one before?” or “Will you return to the prior screen?”, and the characters “× button” for expressing that the button to be pressed to instruct that the prior screen be returned to is the “×” on the controller 3, for example. After displaying the instruction wait display dialog 110 shown in FIG. 10, the call-arrival signaling application program determines whether the user has instructed that the game be returned to (that is, whether the user has pressed the start button 28 to instruct that the pause state be cancelled), or whether the user has instructed that the prior screen be returned to (that is, the user has pressed the “×” button). When the call-arrival signaling application program determines that the user has pressed the “×” button, the call-arrival signaling application program returns to the display state of the electronic mail confirmation dialog 105 shown in FIG. 8. On the other hand, when the call-arrival signaling application program determines that the user has pressed the start button 28 to instruct that the game be returned to, the call-arrival signaling application program closes the instruction wait display dialog 110, cancels the pause state, and returns to step S1 in FIG. 2, thereby to return to the game playing state or the DVD reproduction state.

When the call-arrival signaling application program has determined at step S31 that the pause function has not been supported, the call-arrival signaling application program proceeds to the process at step S39. Then, the call-arrival signaling application program displays the electronic mail reception dialog 103 shown in FIG. 7 and the game playing state or the DVD reproduction state is continued, thereby to signal the arrival of the electronic mail.

Thereafter, the call-arrival signaling application program proceeds to a process at step S40. The call-arrival signaling application program determines whether a predetermined time has elapsed since the start of the display of the electronic mail reception dialog 103. When the call-arrival signaling application program has determined that the predetermined time has elapsed, the call-arrival signaling application program closes the electronic mail reception dialog 103, and returns to step S1 shown in FIG. 2, thereby to return to the game playing state.

When the call-arrival signaling application program has determined at step S40 that the predetermined time has not elapsed, the call-arrival signaling application program determines at step S41 whether the select button 27 on the controller 3 has been pressed. When the call-arrival signaling application program has determined at step S41 that the select button 27 has not been pressed, the call-arrival signaling application program returns to the processing at step S39. When the call-arrival signaling application program has determined at step S41 that the select button 27 has been pressed, the call-arrival signaling application program proceeds to a process at step S42.

At step S42, the call-arrival signaling application program stops the game by using a game application program like the menu display function, and displays the menu screen. In other words, like in the example at step S18 of the flowchart shown in FIG. 3, even if the game application program does not support the pause function, the call-arrival signaling application program according to the present embodiment can stop the game by using the menu display function of the game application program.

After the menu display at step S42, the call-arrival signaling application program determines at step S43 whether the user has selected an item for closing the menu display from among the menu items displayed. When a close instruction has been made, the call-arrival signaling application program closes the electronic mail reception dialog 103 and the menu display, cancels the stop state, and returns to the processing at step S1 shown in FIG. 2, thereby to return to the game playing state. On the other hand, when a close instruction has not been made, the call-arrival signaling application program returns to the processing at step S42.

When the call-arrival signaling application program has determined at step S30 that the pause-impossible function has been set to ON (or when the pause-possible function has been set to OFF), the call-arrival signaling application program proceeds to a process at step S44. The call-arrival signaling application program signals the electronic mail reception by displaying the electronic mail reception dialog 103 shown in FIG. 7 in the state that the play of the game is continued.

Thereafter, the call-arrival signaling application program proceeds to processing at step S45, and determines whether a predetermined time has elapsed. The call-arrival signaling application program repeats the processing at step S44 and step S45 when the predetermined time has not elapsed. When it is determined that the predetermined time has elapsed, the call-arrival signaling application program closes the display of the electronic mail reception dialog 103, returns to step S1 shown in FIG. 2, and returns to the game playing state or the DVD reproduction state.

As explained above, according to the algorithm of the flowchart shown in FIG. 6, like in the example of the flowchart shown in FIG. 3, when the pause-possible function has been set to ON and also when the pause function has been supported, the play of a game or a DVD reproduction is set to the pause state and the electronic mail reception dialog 103 is displayed upon reception of an electronic mail. Further, when the pause function has not been supported, the electronic mail reception dialog 103 is displayed while continuing the play of the game, or the electronic mail reception dialog 103 is displayed in a state that the play of the game is stopped based on the menu display function. Further, the call-arrival signaling application program according to the present embodiment makes it possible to confirm the contents of the received electronic mail.

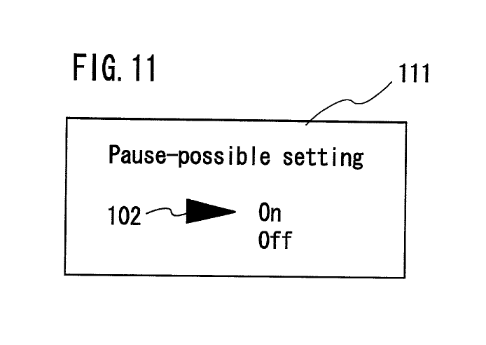

Further, according to the algorithm of the flowchart shown in FIG. 6, when the pause-possible function has been set to OFF, the electronic mail reception dialog 103 is displayed while continuing the play of a game or a DVD reproduction, thereby making it possible to inform the user about the electronic mail reception. At the same time, it is possible to prevent the user from intentionally making time to prepare a game strategy by interrupting the game based on an intentional electronic mail reception during the game that should not be permitted in principle. In the case of an electronic mail, it is necessary to transmit the electronic mail after it has been prepared. Therefore, it is difficult to artificially interrupt the game play. Consequently, in the case of the dialog automatic display processing routine at the time of the reception of the electronic mail, the call-arrival signaling application program can make it possible to avoid the processing at step S30, step S44, and step S45. In such case described in the above, to allow the user to arbitrarily set ON/OFF of the pause-possible function or automatic dialog display, it is proper to display the individual setting screens before the game starts so as to allow the user to perform the setting through operating the controller or the like. FIG. 11 shows an exemplary pause-possible setting screen. In such pause-possible setting screen 111, the user can effect desirable settings by designating ON or OFF while pointing with the cursor 102. It is also possible to design the pause-possible setting screen 111 so as to be displayed even in the progress of the game and so as to be altered in the setting thereof through a specific button operation on occasions.

A Dialog Manual Display Processing Routine at the Time of a Telephone Call Arrival

The telephone call arrival dialog manual display processing function (step S8) when a telephone call arrival has been decided at step S5 shown in FIG. 2 will be explained with reference to FIG. 12.

In the dialog manual display processing routine at the time of a telephone call arrival shown in FIG. 12, the call-arrival signaling application program first signals at step S50 a telephone call arrival in the state that the play of the game or the DVD reproduction is continued. At step S50 of the dialog manual display processing routine, it is possible to realize the signaling of the telephone call arrival by displaying the message “There is an incoming telephone call” at the left top corner of the television monitor screen 99 shown in FIG. 4, or by flickering this message, or by operating the vibration generating mechanism of the controller 3, for example. In other words, the signaling of the telephone call arrival at step S50 is not carried out by occupying a wide area on the monitor screen like the telephone call arrival dialog 101, but is carried out by using a method that does not interrupt the progress of the game or the DVD appreciation. According to the call-arrival signaling application program, it is possible to display a telephone number of the other party, or a name of the other party described in the telephone directory within the portable telephone 4, not only the message expressing the telephone call arrival, as the signaling of the telephone call arrival.

Next, the call-arrival signaling application program proceeds to a process at step S51, and determines whether a telephone call arrival has finished. When the call-arrival signaling application program determines that the call arrival has finished, the call-arrival signaling application program finishes the display signaling the telephone call arrival, returns to step S1 shown in FIG. 2, and returns to the game playing state.

On the other hand, when the telephone call arrival has not finished at step S51, the call-arrival signaling application program determines at step S52 whether the select button 27 on the controller 3 has been pressed. When the call-arrival signaling application program has determined at step S52 that the select button 27 has not been pressed, the call-arrival signaling application program returns to the processing at step S50. When it is determined that the select button 27 has been pressed, the call-arrival signaling application program proceeds to a process at step S53.

The call-arrival signaling application program determines at step S53 whether the pause-possible function has been set to ON or the pause-impossible function has been set to ON (or the pause-possible function has been set to OFF). When the pause-possible function has been set to ON at step S53, the call-arrival signaling application program proceeds to a process at step S54, and when the pause-impossible function has been set to ON (or the pause-possible function has been set to OFF) at step S53, the call-arrival signaling application program proceeds to a process at step S57.

At step S54, the call-arrival signaling application program pauses the game or the DVD reproduction (when it is not possible to pause at present, the call-arrival signaling application program pauses when it becomes possible to do so). After step S54, the call-arrival signaling application program proceeds to a process at step S55.

At step S55, the call-arrival signaling application program signals the telephone call arrival by displaying the telephone call arrival dialog 101 shown in FIG. 5 in the pause state of the game or the DVD reproduction.

Thereafter, the call-arrival signaling application program determines at step S56 whether the user has pressed the start button 28 on the controller 3 to instruct that the pause state be cancelled. When the call-arrival signaling application program has decided that the user has pressed the start button 28 to instruct that the pause state be cancelled, the call-arrival signaling application program closes the display of the telephone call arrival dialog 101. Thereafter, the call-arrival signaling application program cancels the pause state, and returns to step S1 shown in FIG. 2, thereby to return to the game playing state or the DVD reproduction state.

When the call-arrival signaling application program has determined at step S53 that the pause-impossible function has been set to ON (or the pause-possible function has been set to OFF), the call-arrival signaling application program proceeds to a process at step s57. The call-arrival signaling application program signals the telephone call arrival by displaying the telephone call arrival dialog 101 and the game playing state or the DVD reproduction state is continued.

Thereafter, the call-arrival signaling application program determines at step S58 whether the user has pressed the start button 28 on the controller 3 to instruct that the telephone call arrival dialog 101 be closed. When the call-arrival signaling application program determines that the user has pressed the start button 28, the call-arrival signaling application program closes the display of the telephone call arrival dialog 101, and returns to step S1 shown in FIG. 2, thereby to return to the game playing state or the DVD reproduction state. On the other hand, when a close instruction has not been made, the call-arrival signaling application program returns to the process at step S57.

According to the algorithm of the flowchart shown in FIG. 12, so long as there is no clear instruction from the user, the call arrival dialog is not displayed even when there has been a telephone call arrival. Therefore, this makes it possible to achieve a signaling of a telephone call arrival without interrupting the game progress or the DVD appreciation. Consequently, according to the algorithm of the flowchart shown in FIG. 12, when a plurality of persons are playing a game, it is possible to prevent a situation in which a call arrival dialog to show the arrival of a telephone call to one game player is displayed automatically and this affects all of the players.

Further, according to the algorithm of the flowchart shown in FIG. 12, at step S50, it is possible to securely inform a user about the telephone call arrival by flickering the message “There is an incoming call” or by operating the vibration generating mechanism of the controller 3. Particularly, in the present embodiment, when the call-arrival signaling application program operates the vibration generating mechanism of the controller 3 to signal the call arrival, even a person having handicaps in sight or hearing like weak sight can recognize the telephone call arrival. As a result, it is possible to realize a barrier-free specification.

In the example shown in FIG. 12, there is no process for confirming whether a game application program or a DVD reproduction program supports the pause function. However, it is also possible to carry out the processing corresponding to a supporting state of the pause function like in the example shown in FIG. 3. For carrying out the processing corresponding to a supporting state of the pause function, the processing at and after step S10 in FIG. 3 may be employed as the processing at and after step S53 in the algorithm of the flowchart shown in FIG. 12. However, in this case, it is preferable that the select button at step S17 in FIG. 3 not be the same as the select button at step S52 in FIG. 12. It is preferable that one of the buttons at step S17 and step S52 be a separate button. A dialog manual display processing routine at the time of an electronic mail reception

Next, the dialog manual display processing function (step S9) when an electronic mail reception has been determined at step S5 shown in FIG. 2 will be explained with reference to FIG. 13.

In the dialog manual display processing routine at the time of an electronic mail reception shown in FIG. 13, the call-arrival signaling application program first signals at step S60 an electronic mail reception in the state that the play of the game or the DVD reproduction is continued. At step S60 of the dialog manual display processing routine, it is possible to realize the signaling of the electronic mail reception by displaying the message “Electronic mail received” at the left top corner of the television monitor screen 99 shown in FIG. 4, or by flickering this message for a predetermined period of time, or by operating the vibration generating mechanism of the controller 3 for a predetermined period of time, for example. According to the call-arrival signaling application program, it is possible to display an electronic mail address of the other party, or a name of the other party described in the address directory within the portable telephone 4, not only the message expressing the electronic mail reception, as the signaling of the electronic mail reception.

Next, the call-arrival signaling application program proceeds to a process at step S61, and determines whether a predetermined period of time has elapsed after starting the signaling of the electronic mail reception. When the call-arrival signaling application program determines that the predetermined period of time has elapsed, the call-arrival signaling application program finishes the display signaling the electronic mail reception, returns to step S1 shown in FIG. 2, and returns to the game playing state.

On the other hand, when the predetermined period of time has not elapsed at step S61, the call-arrival signaling application program determines at step S62 whether the select button 27 on the controller 3 has been pressed. When the call-arrival signaling application program has determined at step S62 that the select button 27 has not been pressed, the call-arrival signaling application program returns to the processing at step S60. When it is determined that the select button 27 has been pressed, the call-arrival signaling application program proceeds to a process at step S63.

The call-arrival signaling application program determines at step S63 whether the pause-possible function has been set to ON or the pause-impossible function has been set to ON (or the pause-possible function has been set to OFF). When the pause-possible function has been set to ON at step S63, the call-arrival signaling application program proceeds to a process at step S64, and when the pause-impossible function has been set to ON (or the pause-possible function has been set to OFF) at step S63, the call-arrival signaling application program proceeds to a process at step S71.

At step S64 the call-arrival signaling application program pauses the game or the DVD reproduction (when it is not possible to pause at present, the call-arrival signaling application program pauses when it becomes possible to do so). After step S64, the call-arrival signaling application program proceeds to a process at step S65. The call-arrival signaling application program displays the electronic mail reception dialog 103 shown in FIG. 7 in the pause state of the game or the DVD reproduction.

Next, the call-arrival signaling application program determines at step S66 whether the user has pressed the start button 28 on the controller 3 to indicate the confirmation of the contents of the electronic mail. When the user has indicated the confirmation of the contents, the call-arrival signaling application program proceeds to a process at step S67.

At step S67, the call-arrival signaling application program displays the electronic mail confirmation dialog 105 shown in FIG. 8, and determines whether the user has instructed that the electronic mail be read (whether the user has pressed the “O” button) or whether the user has instructed that the game be returned to (whether the user has pressed the “X” button). When the call-arrival signaling application program determines that the user has instructed that the game be returned to, the call-arrival signaling application program closes the electronic mail confirmation dialog 105, cancels the pause state, and returns to step S1 shown in FIG. 2, thereby to return to the game playing state or the DVD reproduction state. On the other hand, when the call-arrival signaling application program determines at step S67 that the user has instructed that the electronic mail be read, the call-arrival signaling application program proceeds to a process at step S68.

In the processing at step S68, the call-arrival signaling application program instructs that the received electronic mail be transferred from the portable telephone 4 shown in FIG. 1, and displays the contents of the electronic mail on the electronic mail display dialog 106 shown in FIG. 9.

Next, at step S69, the call-arrival signaling application program determines whether the user has indicated a confirmation of the electronic mail in the electronic mail display dialog 106. When the call-arrival signaling application program determines that the user has confirmed the contents of the electronic mail, the call-arrival signaling application program proceeds to a process at step S70.

In the processing at step S70, the call-arrival signaling application program displays the instruction wait display dialog 110 shown in FIG. 10, and determines whether the user has instructed that the game be returned to (that is, whether the user has pressed the start button 28) or whether the user has instructed that the prior screen be returned to (that is, the user has pressed the “×” button) When the call-arrival signaling application program determines that the user has instructed that the prior screen be returned to, the call-arrival signaling application program returns to the display state of the electronic mail confirmation dialog 105 shown in FIG. 8. On the other hand, when the call-arrival signaling application program determines that the user has instructed that the game be returned to, the call-arrival signaling application program closes the instruction wait display dialog 110, cancels the pause state, and returns to step S1 in FIG. 2, thereby to return to the game playing state or the DVD reproduction state.

When the call-arrival signaling application program has determined at step S63 that the pause-impossible function has been set to ON (or when the pause-possible function has been set to OFF), the call-arrival signaling application program proceeds to a process at step S71. The call-arrival signaling application program displays the electronic mail reception dialog 103 shown in FIG. 7 and the game playing state or the DVD reproduction state is continued.

The processing at step S72 to step S75 is the same as the processing at step S66 to step S69, except that the play of the game or the DVD reproduction is continued. When the call-arrival signaling application program has determined at step S75 that the user has confirmed the contents of the electronic mail, the call-arrival signaling application program proceeds to a process at step S76.

In the processing at step S76, the call-arrival signaling application program displays the instruction wait display dialog 110 shown in FIG. 10, and determines whether the user has instructed that the game be returned to (that is, whether the user has pressed the start button 28) or whether the user has instructed that the prior screen be returned to (that is, the user has pressed the “×” button). When the call-arrival signaling application program determines that the user has instructed that the prior screen be returned to, the call-arrival signaling application program returns to the display state of the electronic mail confirmation dialog 105 shown in FIG. 8. On the other hand, when the call-arrival signaling application program determines that the user has instructed that the game be returned to, the call-arrival signaling application program closes the instruction wait display dialog 110, and returns to step S1 in FIG. 2, thereby returning to the game playing state or the DVD reproduction state.

According to the algorithm of the flowchart shown in FIG. 13, like in the case of the telephone call arrival shown in FIG. 12, so long as there is no clear instruction from the user, the call arrival dialog is not displayed even when there has been an electronic mail reception. Therefore, this makes it possible to achieve a signaling of an electronic mail reception without interrupting the game progress or the DVD appreciation.

Further, like in the example shown in FIG. 12, according to the call-arrival signaling application program shown in FIG. 13, at step S60, it is possible to securely signal the reception of the electronic mail to a user by flickering the message “Electronic mail received” or by operating the vibration generating mechanism of the controller 3.

Further, like in the example shown in FIG. 12, according to the algorithm of the flowchart shown in FIG. 13, there is no process for confirming whether a game application program or a DVD reproduction program supports the pause function. However, it is also possible to carry out the processing corresponding to a supporting state of the pause function like in the example shown in FIG. 3. For carrying out the processing corresponding to a supporting state of the pause function, according to the call-arrival signaling application program, the processing at and after step S30 in FIG. 6 is employed as the processing at and after step S63 in FIG. 13. However, in this case, it is not preferable that the select button at step S41 in FIG. 6 be the same as the select button at step S62 in FIG. 13. It is preferable that one of the buttons at step S41 and step S62 be a separate button.

Further, in the call-arrival signaling application program according to the present embodiment, the signaling of a telephone call arrival or an electronic mail reception by displaying it at the left top corner of the monitor screen 99, or by flickering the display, or by operating the vibration generating mechanism of the controller 3, and carrying out the ON decision processing by using the select button 27 at step S50 to step S52 in FIG. 12 or at step S60 to step S62 in FIG. 13 can also be executed before step S10 of the telephone call arrival dialog automatic display processing routine in FIG. 3 or before step S30 of the electronic mail reception dialog automatic display processing routine in FIG. 6. Under the application of the processing at step S50 to step S52 or at step S60 to step S62 to the call arrival dialog automatic display processing in FIG. 3 or FIG. 6, according to the present embodiment, it is possible to automatically display the call arrival dialog if the user who received the call arrival signaling during the play of a game or during a DVD reproduction has decided that the game or the DVD appreciation can be progressed without an interruption.

Further, according to the present embodiment, it is also possible to signal a call arrival to a user by generating a sound that is irrelevant to a sound during play of a game or a sound during a DVD reproduction, in addition to the method of signaling a call arrival by displaying the dialog or by operating the vibration generating mechanism. The signaling of a call arrival using a sound can be carried out together with the dialog display or the operation of the vibration generating mechanism, or can be carried out separately. In such processing described with reference to FIGS. 12 and 13, to allow the user to arbitrarily set ON/OFF of the pause-possible function or manual dialog display, it is proper to display the individual setting screens before the game starts so as to allow the user to perform the setting through operating the controller or the like, as typically shown referring to FIG. 11.

According to the present embodiment, the console button used for the call arrival dialog operation is different from the button used for developing a game. With this arrangement, it is possible to avoid an erroneous operation.

In the above embodiment, while description has been made mainly taking the portable telephone 4 as an example, it is also possible to apply the present invention to a case where electronic mail has arrived in the personal computer 5.

An Internal Circuit Structure of a Video Game Unit

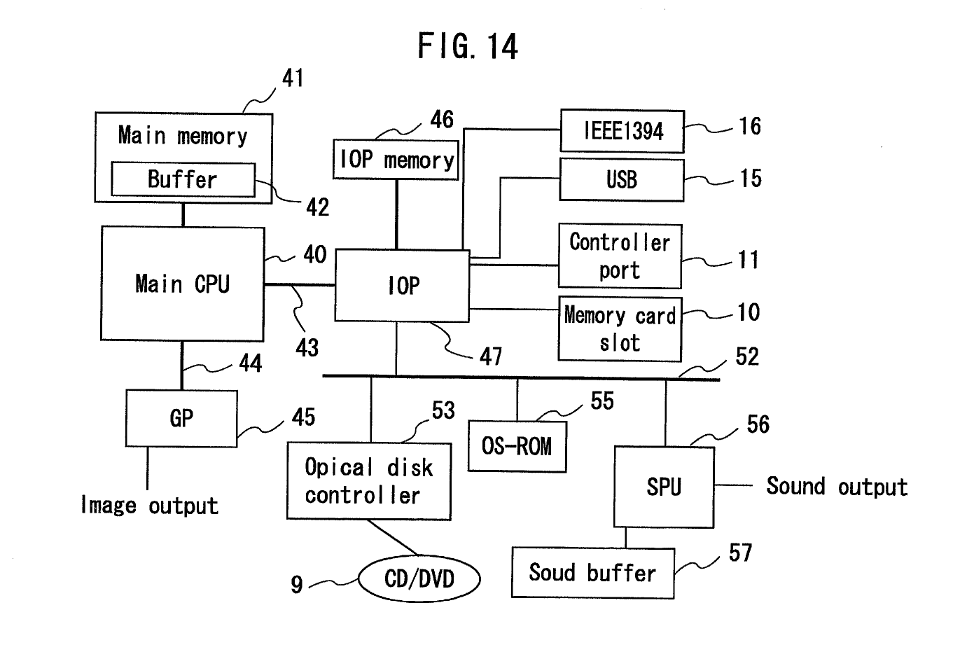

Last, an internal circuit structure of the video game unit 1 shown in FIG. 1 that can be operated according to the call-arrival signaling application program of the present embodiment, a game application program, or a DVD reproduction program will be explained with reference to FIG. 14. The video game unit 1 is provided with the memory card slots 10A and 10B, the controller ports 11A and 11B, the disk tray 12, the IEEE 1394 connection terminal 16, and the USB connection terminal 15 explained above, and can change the operation of an internal CPU based on an application program. As this is basically the same as the video game unit already commercialized by the present applicant, only a schematic structure of the video game unit will be briefly explained below.

The video game unit 1 according to the present embodiment includes as its main structure a main CPU 40 for carrying out signal processing and control of the internal constituent elements based on various kinds of application programs like the call-arrival signaling application program of the present embodiment and a game application program, a graphic processor (GP) 45 for carrying out image processing, an IO processor (IOP) 47 for carrying out interface processing, an optical disk controller 53 for carrying out read control of the optical disk 9 (such as a DVD or a CD) and decoding of the read data, a main memory 41 (including a buffer 42) that is connected to the main CPU 40, an IOP memory 46 for holding an instruction and data that are executed by the IO processor 47, an OS-ROM 55 that mainly stores a program for the operating system, and a sound processor unit (SPU) 56 for carrying out sound signal processing.

The main CPU 40 and the graphic processor 45 are connected to each other via an exclusive bus 44, and the main CPU 40 and the IO processor 47 are connected to each other via an SBUS 43. The IO processor 47, the optical disk controller 53, the OS-ROM 55, and the sound processor unit 56 are connected to each other via an SSBUS 52.

The main CPU 40 executes a program stored in the OS-ROM 55 and the call-arrival signaling application program of the present embodiment and various kinds of game application programs that are read from the optical disk 9 and loaded onto the main memory 41 or downloaded via a communication network.

The graphic processor 45 executes rendering processes in the video game, for example.

The IO processor 47 is connected with a controller port 11 that is connected to the controller 3, a memory card slot 10 that is mounted with the memory card 7, a USB connection terminal 15, and the IEEE 1394 connection terminal 16. The IO processor 47 carries out protocol conversion and data transmission to/from the controller 3 connected via the controller port 11, the memory card 7 connected via the memory card slot 10, and the portable telephone 4 or the personal computer 5 connected via the USB connection terminal 15.

The sound processor unit 56 combines various kinds of sound by reproducing compressed-waveform data stored in the sound buffer 57 in a predetermined sampling frequency based on an instruction from the main CPU 40.

The above embodiment shows one example of the present invention. Therefore, it is of course possible to carry out various modifications to the present invention according to designs within a range not deviating from the technical idea of the present invention, without limiting to the examples in the above embodiment. For example, the entertainment apparatus of the present invention is not limited to the video game unit explained in the above embodiment, and may be a DVD player. It is also possible that the portable telephone 4, in place of the program execution device, is connected to the personal computer via a USB cable or the like to thereby enable the call-arrival signaling or mail-arrival signaling on the portable telephone 4 similarly to the above embodiment. While the above description dealt with a case that the portable telephone 4 and the video game unit 1 were connected with the exclusive cable 17, the connection may also be accomplished in a wireless manner. Such wireless connection is embodied by connecting a wireless receiver to the USB connection terminal 15 of the video game unit 1, and separately attaching a wireless sender to the portable telephone 4. The wireless sender and wireless receiver referred to herein can typically be those supporting a so-called Bluetooth connection. Further, the call-arrival signaling application program of the present embodiment may be an independent program stored, for example, in the memory card 7 or OS-ROM 55, or may be a part of a game application program.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A call-arrival signaling method, comprising:
detecting a connection with a communication terminal;
detecting a presence or absence of a call arrival in the communication terminal during an execution of a program; and
signaling the call arrival when the presence of the call arrival has been detected.

2. A program execution device, comprising:
a connector operable to create a data connection with a communication terminal;
a detector operable to detect a presence or absence of a call arrival in the communication terminal during an execution of a program; and
a signaling section operable to generate a signal indicating the call arrival when the presence of the call arrival has been detected.

3. The program execution device according to claim 2, further comprising:
an interrupting section for interrupting the execution of the program when the presence of the call arrival has been detected.

4. The program execution device according to claim 3, wherein the interrupting section interrupts the execution of the program either automatically or based on an instruction from a user.

5. The program execution device according to claim 3, wherein the interrupting section interrupts the execution of the program by using a pause function.

6. The program execution device according to claim 5, wherein, when it is not possible to use the pause function to interrupt the execution of the program at a selected time, the interrupting section waits to use the pause function to interrupt the execution of the program until a time after the selected time.

7. The program execution device according to claim 3, wherein the interrupting section searches for a stop function capable of stopping the execution of the program and interrupts the execution of the program by using the stop function.

8. The program execution device according to claim 2, wherein the signaling section changes a state of the signal according to a type of the call arrival.

9. The program execution device according to claim 3, wherein the interrupting section determines whether it is possible to interrupt the execution of the program according to a type of the call arrival.

10. The program execution device according to claim 2, wherein the signaling section generates a display signal on a monitor screen as the signal indicating the call arrival.

11. The program execution device according to claim 10, wherein the signaling section generates a contents display signal for displaying contents of the call arrival on the monitor screen according to an instruction from a user.

12. The program execution device according to claim 2, wherein the signaling section generates a vibration control signal for indicating the call arrival by vibration, and controls a vibrating unit with the vibration control signal.

13. The program execution device according to claim 2, wherein the signaling section generates a sound signal for indicating the call arrival by sound, and controls a predetermined vibrating unit with the sound signal.

14. A program execution system, comprising:
a communication terminal;
a program execution device connected to the communication terminal and operable to detect a presence or absence of a call arrival in the communication terminal during an execution of a program, and to generate a signal when the presence of the call arrival has been detected; and
a signaling unit operable to indicate the call arrival according to the signal.

15. The program execution system according to claim 14, wherein the signal is a display signal and the signaling unit includes a monitoring unit having a monitor screen for displaying the display signal.

16. The program execution system according to claim 14, wherein the signaling unit includes a vibrating unit and the signal generated by the program execution device is a vibration control signal for controlling the vibrating unit.

17. The program execution system according to claim 14, wherein the signaling unit includes a sound discharging unit and the signal generated by the program execution device is a sound signal for driving the sound discharging unit.

18. A computer-readable recording medium having recorded therein a call-arrival signaling program to be executed on a computer, the call-arrival signaling program comprising:
detecting a connection with a communication terminal;
detecting a presence or absence of a call arrival in the communication terminal during an execution of another program; and
generating a signal indicating the call arrival when the presence of the call arrival has been detected.

19. The computer-readable recording medium according to claim 18, the call-arrival signaling program further comprising:
interrupting the execution of the another program when the presence of the call arrival has been detected.

20. The computer-readable recording medium according to claim 19, wherein the interrupting step includes interrupting the execution of the another program either automatically or based on an instruction from a user.

21. The computer-readable recording medium according to claim 19, wherein the interrupting step includes interrupting the execution of the program by using a pause function.

22. The computer-readable recording medium according to claim 21, wherein, when it is not possible to use the pause function to interrupt the execution of the another program at a selected time, the interrupting step further includes waiting until a time after the selected time to use the pause function to interrupt the execution of the another program.

23. The computer-readable recording medium according to claim 19, wherein the interrupting step includes searching for a stop function capable of stopping the execution of the another program, and interrupting the execution of the another program by using the stop function.

24. The computer-readable recording medium according to claim 18, wherein the generating step includes changing a state of the signal according to a type of the call arrival.

25. The computer-readable recording medium according to claim 19, wherein the interrupting step includes determining whether it is possible to interrupt the execution of the another program according to a type of the call arrival.

26. The computer-readable recording medium according to claim 18, wherein the generating step includes generating a display signal on a monitor screen as the signal indicating the call arrival.

27. The computer-readable recording medium according to claim 26, wherein the generating step further includes generating a contents display signal for displaying contents of the call arrival on the monitor screen according to an instruction from a user.

28. The computer-readable recording medium according to claim 18, wherein the generating step includes generating a vibration control signal for indicating the call arrival by vibration, and controlling a vibrating unit with the vibration control signal.

29. The computer-readable recording medium according to claim 18, wherein the generating step includes generating a sound signal for indicating the call arrival by sound, and controlling a vibrating unit with the sound signal.
